(19) United States
(12) Patent Application Publication
(10) Pub. No.: US 2026/0356131 A1
(43) Pub. Date: Nov. 12, 2026

(54) VEHICLE TYRE

(71) Applicant: Continental Reifen Deutschland GmbH, Hannover (DE)

(72) Inventors: Stefan Rittweger, Garbsen (DE); Juraj Jurco, Hannover (DE)

(73) Assignee: Continental Reifen Deutschland GmbH, Hannover (DE)

(21) Appl. No.: 19/111,888

(22) PCT Filed: Aug. 15, 2023
(86) PCT No.: PCT/DE2023/200167

§ 371 Date: Mar. 14, 2025

(30) Foreign Application Priority Data
Sep. 21, 2022 (DE) 10 2022 209 943.5

(51) Int. Cl. B60C 13/00; B60C 11/03

(52) U.S. Cl. CPC B60C 13/001; B60C 11/03

(57) ABSTRACT

A vehicle tire having sidewalls and a tread and having at least one hatching area on at least one of the sidewalls and/or on the tread. The hatching area has elongate hatching ribs which extend alongside one another and which have longitudinal-extent directions which extend parallel to one another or largely parallel to one another. The hatching ribs, when seen in plan view, each extend with a regular waveform and are each made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, with two freely ending additional ribs branch off from each rib portion.

The invention relates to a vehicle tire, in particular to a pneumatic vehicle tire, having sidewalls and a tread and having at least one hatching area on at least one of the sidewalls and/or on the tread, wherein the hatching area has elongate hatching ribs which extend alongside one another and which have longitudinal-extent directions which extend parallel to one another or largely parallel to one another.

Hatching areas are normally stamped into the tire at the outer side by means of a shape-imparting vulcanization mold, which has a negative contour of the respective hatching area on a mold surface, during the vulcanization of the tire. A hatching area or a surface element forming a structured hatching area can be produced on an already vulcanized tire by removal of material, by means of engraving, or by an additive process.

The primary purpose of hatching areas formed on sidewalls or shoulder flanks of the vehicle tire is to create a contrast with existing smooth surface regions on sidewalls or shoulder flanks of the vehicle tire, with special attention being paid to good visibility and identifiability, for example in order for letterings, pictorial elements, company logos, other identifiers and the like situated on the sidewalls to be optically emphasized. The same applies to hatching areas situated on groove flanks of grooves in the tread. In this case, the hatching area may be part of the letterings, pictorial elements, company logos or other identifiers or completely or partially surround or encircle these. Hatching areas can also be used to conceal design-related unevennesses on the sidewalls.

Vehicle tires of the type mentioned at the beginning that have hatching areas on sidewalls with hatching ribs extending alongside one another are known for example from EP 2 502 758 A1 and DE 10 2008 010 486 A1.

The scattering of light at flanks of hatching ribs reduces the degree of reflection of the light at the surface of the tire, whereby the brightness effect of the hatching area is changed and the hatching area normally appears darker than substantially smooth surface regions that are free of hatching areas. Although in particular hatching areas composed of hatching ribs extending parallel to one another can be engraved highly effectively as negative contours into a mold surface of a vulcanization mold for shape-imparting vulcanization of the vehicle tire, for example by means of a laser, and subsequently stamped with good quality in the rubber material during the vulcanization of the tire, the contrast effect thereof is highly dependent on the direction of the light incidence. The contrast can therefore suddenly be reduced at certain viewing angles.

The invention is therefore based on the object of influencing, in particular increasing, the contrast effect of the hatching area(s) with hatching ribs in all light situations and at all angles of light incidence in a targeted manner, and in the process finding a good compromise between an improved contrast effect and effective producibility—with respect to the tire-vulcanization mold—at the same time, in the case of a vehicle tire of the type mentioned at the beginning.

The set object is achieved by a vehicle tire as claimed in claim 1, a vulcanization mold as claimed in claim 14, and a method as claimed in claim 15.

The vehicle tire according to the invention is characterized in that the hatching ribs, when seen in plan view, each extend with a regular waveform and are each made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, wherein, on that side of the hatching ribs on which a hatching-rib base line extending along the long trapezoid bases or along the arc chords of the arcs is positioned, two freely ending additional ribs branch off from each rib portion.

The hatching ribs extending in an undulating manner according to the invention provide, together with the additional ribs, a multiplicity of rib flanks which extend in different directions and at which light incident from all possible directions is scattered, reflected multiple times and absorbed in such a way that a particularly high contrast effect is achieved. Thus, at all viewing angles, the hatching areas appear to be particularly dark and contrast-rich. In addition, shadow effects that promote clear emphasis of the hatching area, particularly on the black rubber of the vehicle tire, occur.

Contrast measurements carried out by us by means of an Ulbricht sphere demonstrate the excellent contrast effect of the hatching areas. In each case, a contrast value, resulting from the ratio of the measured black value of the hatching area and the measured black value of the surrounding smooth area, was ascertained. In the case of hatching areas designed according to the invention, a contrast value of approximately 2.7 was ascertained. By contrast, customary standard hatching areas originating from a negative contour milled into a mold surface of a vulcanization mold have a contrast value of approximately 1.3 to 1.5.

A first preferred embodiment is characterized in that the additional ribs branching off from the same rib portion, when seen in plan view, extend in a V-shaped manner with respect to one another and in a manner inclined oppositely with respect to one another in relation to the longitudinal-extent direction of the hatching rib and approach one another in the direction of the hatching rib. As a result, the contrast effect of the hatching ribs is further improved at all viewing angles, independently of the direction of incidence of the light.

In this preferred embodiment, it is advantageous if the additional ribs branching off from the same rib portion, when seen in plan view, are inclined correspondingly relative to the longitudinal-extent direction of the hatching rib. This further improves the light scattering at the hatching ribs.

Furthermore, in this preferred embodiment, it is expedient if the additional ribs extending in a V-shaped manner with respect to one another include an angle of 15° to 25°, in particular of 18° to 22°. This ensures a “density” of the additional ribs that is particularly advantageous with regard to the light scattering at the additional ribs.

A further preferred embodiment is characterized in that the additional ribs branching off from the same rib portion adjoin the respective hatching rib with a mutual spacing. This contributes to a further increase in the contrast value of the hatching area.

According to a further preferred embodiment, the additional ribs, when seen in plan view, pass through the hatching-rib base line, wherein the additional ribs, when seen in plan view, preferably each have a first additional-rib portion, which extends from the hatching-rib base line to the hatching rib, and a second additional-rib portion, which adjoins, and is configured to be longer than, the first additional-rib portion. The additional ribs therefore project significantly from the hatching ribs, which is likewise expedient for the contrast value.

The additional ribs preferably have a width which decreases continuously to the hatching rib. As a result, during the vulcanization of the tire, the mutual connection region of each additional rib to the hatching rib is formed in a particularly faithfully detailed and exact manner, whereby the contrast effect is further improved.

A further preferred embodiment is characterized in that the rib portions extend in the manner of isosceles trapezoids without a long base, so that each rib portion is made up of a rib-portion part which forms the short base of the trapezoid and of two rib-portion parts which form a trapezoid leg in each case, wherein the one additional rib proceeds from the mutual connection region of the rib-portion part forming the short base of the trapezoid at the rib-portion part forming the one trapezoid leg, and the other additional rib proceeds from the mutual connection region of the rib-portion part forming the short base of the trapezoid at the rib-portion part forming the other trapezoid leg. In this embodiment, too, during the vulcanization of the tire, the mutual connection region of each additional rib to the hatching rib is formed in a particularly faithfully detailed and exact manner. The contrast effect is thus further improved.

According to a further preferred embodiment, the additional ribs each have an extent length of 0.30 mm to 0.50 mm, in particular of 0.35 mm to 0.45 mm.

Furthermore, it is advantageous for the contrast effect if the rib portions of all the hatching ribs point in a manner oriented correspondingly in relation to the longitudinal-extent direction and thus point in a corresponding direction in relation to the longitudinal-extent direction. This allows the hatching ribs to be arranged with a particularly high density and, at the same time, also to be designed in a faithfully detailed manner.

A further preferred embodiment is characterized in that hatching ribs extending adjacently to one another have to one another a mutual spacing, based on the hatching-rib base lines and ascertained perpendicularly thereto, of at least 0.50 mm, and in particular of up to 0.80 mm.

A likewise preferred embodiment, through which the contrast effect is further improved, is characterized in that the hatching ribs extending directly alongside one another are offset from one another in their longitudinal-extent direction.

In a particularly preferred variant, the first preferred embodiment is combined with the last-mentioned preferred embodiment in such a way that the hatching ribs extending directly alongside one another are offset from one another in their longitudinal-extent direction in such a way that, in each case when seen in plan view,
for each middle hatching rib, which has two adjacently extending hatching ribs, the additional ribs, extending parallel to one another, that form the one V leg extend in a manner aligned with the corresponding additional ribs from the one adjacent hatching rib and the additional ribs, extending parallel to one another, that form the other V leg extend in a manner aligned with the corresponding additional ribs from the other adjacent hatching rib, and
for each edge-side hatching rib, which has one adjacently extending hatching rib, only the additional ribs, extending parallel to one another, that form the one V leg extend in a manner aligned with the corresponding additional ribs from the adjacent hatching rib.

A further preferred embodiment is characterized in that, between the additional ribs branching off from the same rib portion, there is formed in each case one free-standing, peg-shaped elevation which has a maximum height of 0.05 mm to 0.80 mm, in particular of 0.10 mm to 0.50 mm, wherein the maximum height of the peg-shaped elevation is preferably less than the maximum height of the additional ribs, and/or wherein the maximum height of the peg-shaped elevation is preferably less than the maximum height of the hatching ribs. The peg-shaped elevations therefore occupy corresponding free spaces in the region between the additional ribs, whereby the contrast effect is likewise improved.

The invention furthermore relates to a vulcanization mold for shape-imparting vulcanization of a vehicle tire as claimed in one or more of claims 1 to 14, wherein the vulcanization mold has at least one mold surface having a negative contour of a hatching area with elongate hatching ribs which extend alongside one another and which have longitudinal-extent directions which extend parallel to one another or largely parallel to one another, wherein the negative contour has the following:
first depressions for forming hatching ribs, said hatching ribs, when seen in plan view, each extending with a regular waveform and each being made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, and
second depressions for forming on that side of the hatching ribs on which a hatching-rib base line extending along the long trapezoid bases or along the arc chords of the arcs is positioned two freely ending additional ribs which branch off from each rib portion,
The invention furthermore relates to a method for producing a vehicle tire as claimed in one of claims 1 to 14, wherein the method comprises the following steps:
a) engraving a negative contour for forming a hatching area into a mold surface of a vulcanization mold for shape-imparting vulcanization of a vehicle tire by means of laser engraving, wherein the negative contour has the following:
   first depressions for forming hatching ribs, said hatching ribs, when seen in plan view, each extending with a regular waveform and each being made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, and
   second depressions for forming on that side of the hatching ribs on which a hatching-rib base line extending along the long trapezoid bases or along the arc chords of the arcs is positioned two freely ending additional ribs which branch off from each rib portion,
b) performing shape-imparting vulcanization of a tire blank by means of the vulcanization mold, whereby a hatching area with hatching ribs and additional ribs is stamped into an outer surface of the vehicle tire, in particular a sidewall and/or the tread of the vehicle tire.

Further features, advantages and details of the invention will now be described in more detail on the basis of the drawing, which schematically shows exemplary embodiments of the invention. In the drawing:

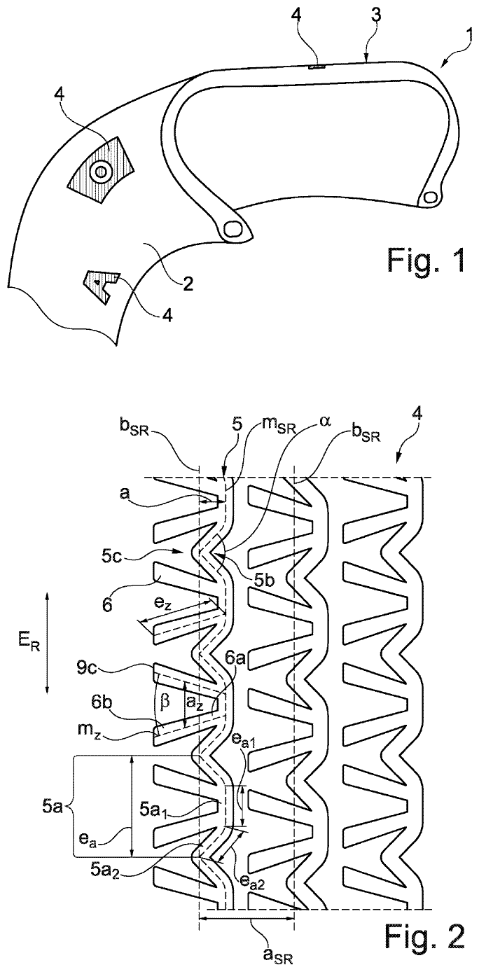

FIG. 1 shows a view of a vehicle tire with hatching areas,

FIG. 2 shows a schematic, enlarged plan view of a detail of a hatching area with a first embodiment variant of the invention, wherein longitudinal portions of hatching ribs can be seen,

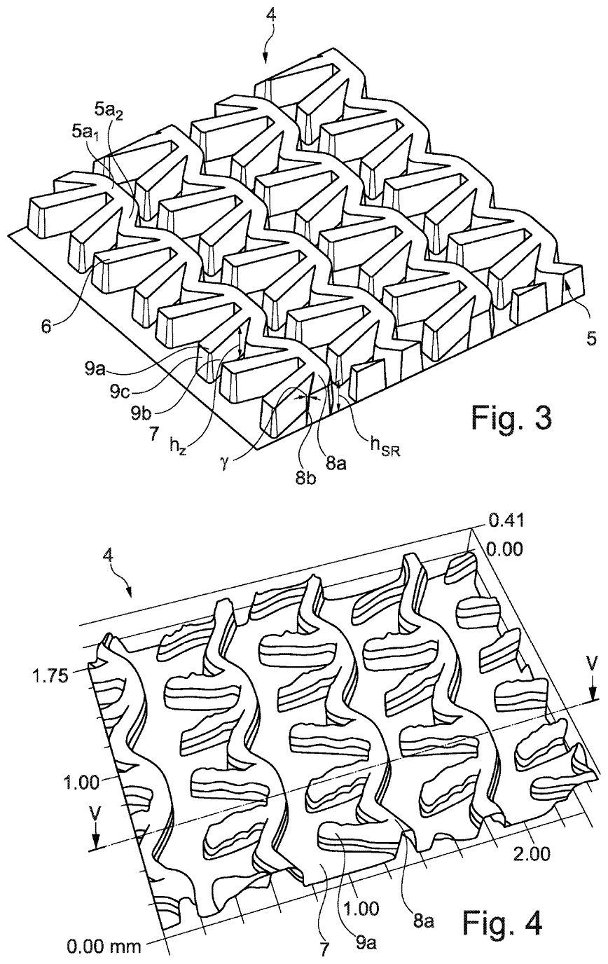

FIG. 3 shows a schematic oblique view of a part of the detail from FIG. 2,

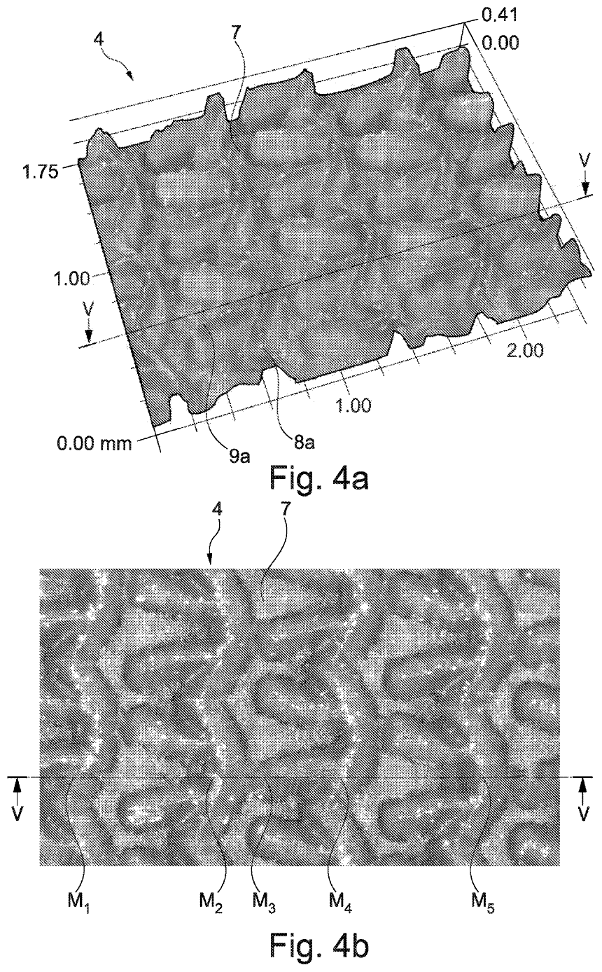

FIG. 4 shows a schematic oblique view of a part of the detail from FIG. 2, wherein the oblique view is based on a scan created by an electron microscope,

FIG. 4a shows the photographic image of the scan associated with FIG. 4,

FIG. 4b shows a plan view of a part of the image of the scan from FIG. 4a,

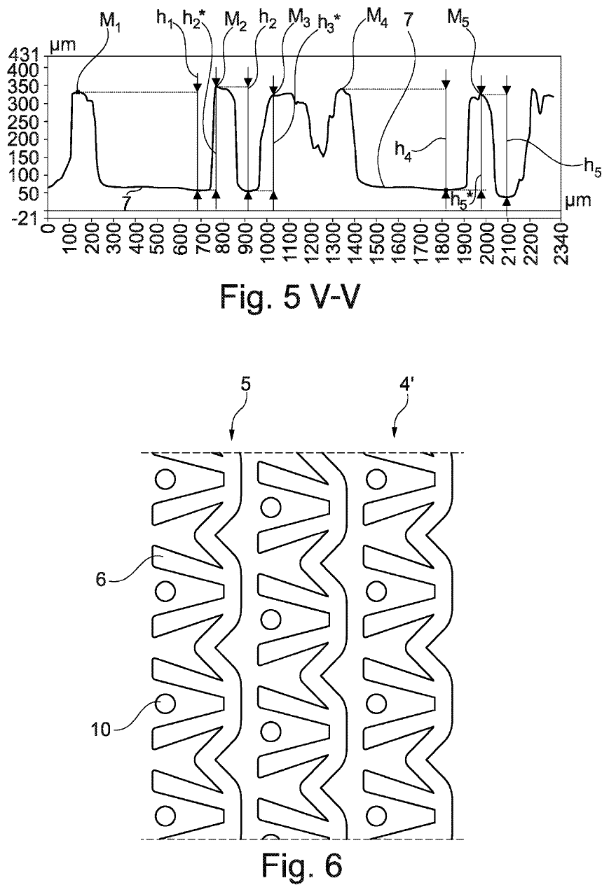

FIG. 5 shows a section along the line V-V in FIG. 4, FIG. 4a and FIG. 4b, wherein the section is based on the scan,

FIG. 6 shows a schematic, enlarged plan view of a detail of a hatching area with a second embodiment variant of the invention, wherein longitudinal portions of hatching ribs can be seen,

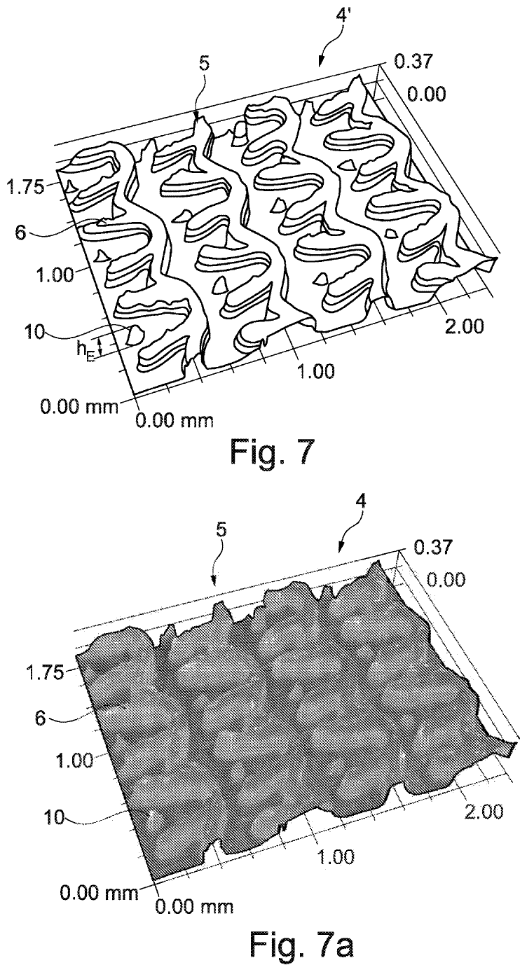

FIG. 7 shows an oblique view of a part of the detail from FIG. 6, wherein the oblique view is based on a scan created by an electron microscope, and

FIG. 7a shows the photographic image of the scan associated with FIG. 7.

FIG. 1 shows a circumferential portion of a vehicle tire 1 with sidewalls 2, with a tread 3 and with hatching areas 4 on the outer side of the one sidewall 2 and (indicated) on the tread 3. The vehicle tire is preferably a pneumatic vehicle tire, in particular for passenger motor vehicles, vans, SUVs, light trucks, utility vehicles, motorcycles, buses or bicycles. The hatching areas 4 are areal elements that are embodied in any desired external configuration, for example as an image, as a logo or as a character. The hatching areas 4 may also be formed on groove flanks and/or groove bases of grooves formed in the tread 3, or on the tread runout, that is to say on the shoulder flanks which run to the side walls outside the ground contact area on the shoulder side.

As shown in FIG. 2 and FIG. 3, the hatching area 4 has elongate hatching ribs 5 which extend alongside one another and which have a longitudinal-extent direction E_{R} (FIG. 2), wherein the hatching ribs 5, when seen in plan view (FIG. 2), extend with a regular waveform. In the embodiment shown, the longitudinal-extent direction E_{R} is a straight line, but may also extend in a preferably altogether arcuate or undulating manner.

Below, an idealized form of the hatching area 4 and of the hatching ribs 5 belonging thereto (shown in FIG. 2 and FIG. 3) will be explained first of all, and differences from the form of the hatching area 4 actually to be found on the vehicle tire (shown in FIG. 4, FIG. 4a, FIG. 4b, FIG. 5) will be discussed subsequently.

According to FIG. 2, the hatching ribs 5 each have a hatching-rib base line b_{SR} which extends in the longitudinal-extent direction E_{R} and on the basis of which the maximum deflection a of the waveform, which corresponds to twice the amplitude of the waveform, is ascertained. The hatching ribs 5 furthermore each have a hatching-rib midline m_{SR}, which in plan view follows the profile thereof, and are each made up of mutually adjoining rib portions 5a which, when seen in plan view, extend in the manner of isosceles trapezoids without a long base that are oriented correspondingly in relation to the longitudinal-extent direction E_{R}. In the exemplary embodiment, the rib portions 5a of all the hatching ribs 5 are oriented correspondingly in relation to the longitudinal-extent direction E_{R} and thus point in a corresponding direction in relation to the longitudinal-extent direction E_{R}. The hatching-rib base line b_{SR} extends along the missing long trapezoid bases of the trapezoids and is based on the hatching-rib midline m_{SR}. The rib portions 5a are therefore able to be mapped onto one another by parallel displacement in the longitudinal-extent direction E_{R}. Each rib portion 5a is made up of a rib-portion part 5a₁ forming the short base of the trapezoid, which in plan view extends straight and extends in the longitudinal-extent direction E_{R}, and of two rib-portion parts 5a² forming a trapezoid leg in each case, which in plan view extend straight.

Due to the profile of the hatching ribs 5, the in each case mutually adjoining rib-portion parts 5a₂ belonging to different rib portions 5a and forming trapezoid legs form at their mutual connection in each case one inner corner region 5b and one pointed outer corner region 5c, wherein, at the inner corner regions 5b, the rib-portion parts 5a₂ include an inner angle α, based on the hatching-rib midline m_{SR}, of 80° to 120°, in particular of 85° to 110°, preferably of up to 95°, with one another.

The rib portions 5a each have an extent length eₐ, based on the hatching-rib base line b_{SR}, of 0.40 mm to 1.00 mm, in particular of 0.50 mm to 0.80 mm. The rib-portion parts 5a₁ in each case have an extent length eₐ₁ (for rib-portion part 5a₁) and an extent length eₐ₂ (for rib-portion part 5a₂), as ascertained along the hatching-rib midline m_{SR}, wherein the extent length eₐ₁ preferably is 0.15 mm to 0.40 mm, in particular up to 0.30 mm, preferably 0.20 mm to 0.25 mm, and is preferably matched to the inner angle α in such a way that the extent length eₐ₂ corresponds to the extent length eₐ₁ or differs from the latter at most by 0.05 mm.

As shown in FIG. 2 and FIG. 3, on that side of each hatching rib 5 on which the hatching-rib base line b_{SR} (FIG. 2) is positioned, two freely ending additional ribs 6, which in plan view extend straight and extend in a V-shaped manner with respect to one another and pass through the hatching-rib base line b_{SR} (FIG. 2), branch off from each rib portion 5a (FIG. 2), wherein one additional rib 6 proceeds from the mutual connection region of the rib-portion part 5a₁ and the rib-portion part 5a₂ that forms the one trapezoid leg and one additional rib 6 proceeds from the mutual connection region of the rib-portion part 5a₁ and the rib-portion part 5a₂ that forms the other trapezoid leg. With regard to the shape of a V, the V-shaped tip is thus replaced by the rib-portion part 5a₁ which extends between the respective additional ribs 6 extending in a V-shaped manner with respect to one another. According to FIG. 2, the additional ribs 6, together with the rib portions 5a, are able to be mapped onto one another by parallel displacement in the longitudinal-extent direction E_{R}, wherein the additional ribs 6, in each case when seen in plan view, have a rib midline m_{Z}, which follows the profile thereof and is continued as far as the hatching-rib midline m_{SR}, an extent length e_{Z}, ascertained along the rib midline m_{Z}, of 0.30 mm to 0.50 mm, in particular of 0.35 mm to 0.45 mm, and a width decreasing continuously to the hatching rib 5, which in plan view is ascertained perpendicularly to the rib midline m_{Z}. Additional ribs 6 branching off from the same rib portion 5a are inclined oppositely with respect to one another in relation to the longitudinal-extent direction E_{R} in such a way that a mutual spacing a_{Z} ascertained therebetween in the longitudinal-extent direction E_{R}, which is based on the rib midline m_{Z}, increases continuously as the distance from the rib-portion part 5a₁ increases and said additional ribs include an angle β, based on the rib midlines m_{Z}, of 15° to 25°, in particular of 18° to 22°, with one another. Preferably, the additional ribs 6, when seen in plan view, are inclined to a corresponding extent (at an angle of a corresponding size) relative to the longitudinal-extent direction E_{R}. The additional ribs 6, when seen in plan view, each have a first additional-rib portion 6a, which extends from the hatching-rib base line b_{SR} to the hatching rib 5, and a second additional-rib portion 6b, which adjoins, and is configured to be longer than, the first additional-rib portion 6a.

Thus, within each hatching rib 5, the additional ribs 6 include additional ribs 6 which extend parallel to one another in plan view and additional ribs 6 which are inclined oppositely with respect to these additional ribs 6 in relation to the longitudinal-extent direction E_{R} and which likewise extend parallel to one another in plan view.

If the extent lengths eₐ₁, eₐ₂ correspond, the extent length e_{Z} is particularly preferably greater than the extent lengths eₐ₁, eₐ₂ by at least 0.10 mm.

If the extent length eₐ₁ differs from the extent length eₐ₂, the extent length e_{Z} is particularly preferably greater than the greater of the two extent lengths eₐ₁, eₐ₂ by at least 0.10 mm.

The hatching ribs 5 extending alongside one another within a hatching area 4 are offset from one another in their longitudinal-extent direction E_{R}. The offset is preferably configured in such a way that, when seen in plan view, for each middle hatching rib 5, which has two adjacently extending hatching ribs 5, the one set of additional ribs 6 extending parallel to one another extend in a manner aligned with the corresponding additional ribs 6 from the one adjacent hatching rib 5 and the other set of additional ribs 6 extending parallel to one another extend in a manner aligned with the corresponding additional ribs 6 from the other adjacent hatching rib 5. Accordingly, for each edge-side hatching rib 5, only the one set of additional ribs 6 extending parallel to one another extend in a manner aligned with the corresponding additional ribs 6 from the adjacent hatching rib 5.

Mutually adjacent hatching ribs 5 have to one another a mutual spacing as, based on the hatching-rib base lines b_{SR} and ascertained perpendicularly thereto, of at least 0.50 mm, and in particular of up to 0.80 mm.

In accordance with FIG. 3, the hatching ribs 5 are preferably situated on a hatching base 7, which is for example the bottom of a flat depression formed in the sidewall 2 (FIG. 1) of the tire. The hatching ribs 5 are thus elevations proceeding from the hatching base 7, that is to say formed thereon, and have a trapezoid-like, triangular or triangle-like cross section with a tip region 8a and two rib flanks 8b which fall in the direction of the hatching base 7 and which each extend at an acute angle γ of up to 10°, in particular of 2° to 10°, preferably of 3° to 5°, to a perpendicular to the hatching base 7 and transition into the hatching base 7 via a bend or a rounded portion. The hatching ribs 5 furthermore have a maximum height h_{SR} (height at the highest point) of 0.10 mm to 0.80 mm, preferably of 0.20 mm to 0.50 mm, particularly preferably of 0.25 mm to 0.35 mm, said maximum height being ascertained perpendicularly to the hatching base 7. The tip region 8a is in the form of a plateau which is 0.05 mm to 0.10 mm wide and which extends continuously over the entire hatching rib 5. In an alternative embodiment, the tip region 8a is a rounded portion between the upper ends of the rib flanks 8b.

The additional ribs 6 have a trapezoid-like, triangular or triangle-like cross section which corresponds to the hatching rib 5, have a tip region 9a and rib flanks 9b which likewise include the mentioned angle γ (not indicated) with a perpendicular to the hatching base 7 and which transition into the hatching base 7 via a bend or a rounded portion. The additional ribs 6 have a maximum height h_{Z}, ascertained perpendicularly to the hatching base 7, which corresponds to the maximum height h_{SR} of the hatching ribs 5. At their free ends, the additional ribs 6 have an end flank 9c which, in the illustrated exemplary embodiment, is a largely planar surface which is a surface that falls obliquely in the direction of the hatching base 7 at an angle, ascertained relative to a reference line positioned perpendicular to the hatching base 7, of up to 5° or which extends perpendicularly to the hatching base 7 and preferably substantially parallel to the extent direction E_{R} (cf. FIG. 1). In an alternative embodiment (not shown), the end flank 9c is overall in the form of a rounded portion between the rib flanks 9b.

FIG. 4 shows a schematic oblique view of the hatching area 4, FIG. 4a shows an oblique view of a scan of the hatching area 4 created by an electron microscope, and FIG. 4b shows a plan view of a part of the scan from FIG. 4a. FIG. 5 shows a section along the line V-V in FIG. 4, FIG. 4a and FIG. 4b.

In comparison with the idealized form of the hatching area 4 shown in FIG. 2 and FIG. 3, the hatching area 4 actually to be found on the tire—as shown in FIG. 4, FIG. 4a and FIG. 4b—is characterized by an irregularity which extends over the entire hatching area 4 and which is caused by the production process, the latter being discussed below. Here, the hatching base 7 has an area-covering irregular roughness (FIG. 4a, FIG. 4b, FIG. 5), and the rib flanks 8b, 9b and the end flanks 9c in each case have an irregular, slight undulation. The rib flanks 8b, 9b and the end flanks 9c are therefore substantially planar, unstructured surfaces. Furthermore, the tip regions 8a, 9a (FIG. 4, FIG. 4a) are characterized by a height which changes irregularly and to an extremely small extent, so that the maximum height h_{SR}, h_{Z} (FIG. 3) is subject to a certain fluctuation.

FIG. 4b and FIG. 5 indicate a number of measurement points M_{i, i=1 to 5} at which the maximum height, ascertained perpendicularly to the hatching base 7, has been ascertained in each case.

As shown in FIG. 5, in the section shown, there are different maximum heights at the tip regions 8a, 9a (FIG. 4) in relation to the adjacent, in each case lowest level of the hatching base 7. The maximum heights ascertained in FIG. 5 relative to the lowest level of the hatching base 7 on the left-hand side are denoted by an *. The following maximum heights were measured in the section shown:
h₁=0.276 mm
h₂=0.293 mm
h₂*=0.291 mm
h₃*=0.270 mm
h₄=0.283 mm
h₅=0.288 mm
h₅*=0.268 mm

The irregularities caused by the production process result in the “constant” maximum height varying within an interval of up to 0.03 mm.

FIG. 6 and FIG. 7 show a detail of a hatching area 4′ that is a variant of the hatching area 4. The hatching area 4′ differs from the hatching area 4 in that, in the region of each hatching rib 5, there is formed between the additional ribs 6 extending in a V-shaped manner with respect to one another in each case one elevation 10 which is punctiform in plan view, free-standing and peg-shaped overall. The peg-shaped elevation 10 has a maximum height h_{E} (FIG. 7) of 0.05 mm to 0.80 mm, in particular of 0.10 mm to 0.50 mm, wherein the maximum height h_{E} is preferably less than the maximum height h_{Z} (FIG. 3) of the additional ribs 6 and less than the maximum height h_{SR} (FIG. 3) of the hatching ribs 5. FIG. 7a shows an oblique view of a scan of the hatching area 4′ created by an electron microscope.

A method for producing the pneumatic vehicle tire with the hatching areas 4 will be discussed below.

The hatching areas 4 are produced on the surface of a vehicle tire 1, for instance on the sidewall 2, during the shape-imparting vulcanization of the vehicle tire 1. To this end, the vulcanization mold used has a mold surface which contains a negative contour of the hatching areas 4 to be created.

The method for producing the vehicle tire 1 comprises the following steps:
a) engraving a negative contour for forming a hatching area 4 into a mold surface of a vulcanization mold for shape-imparting vulcanization of a vehicle tire 1 by means of laser engraving,
wherein the negative contour has first depressions for forming the hatching ribs 5 and second depressions for forming the additional ribs 6,
c) performing shape-imparting vulcanization of a tire blank by means of the vulcanization mold, whereby a hatching area 4 with hatching ribs 5 and additional ribs 6 is stamped into an outer surface of the vehicle tire, in particular a sidewall and/or the tread of the vehicle tire.

The invention is not limited to the exemplary embodiments described.

Hatching ribs of a hatching area extending alongside one another may also extend without an offset or offset from one another in any desired manner in the longitudinal-extent direction E_{R}. The rib portions of the hatching ribs may, when seen in plan view, also extend in the manner of arcs oriented correspondingly in relation to the longitudinal-extent direction E_{R} (and therefore in a circular-arc-shaped manner), wherein, on that side of the hatching ribs on which a hatching-rib base line extending along the arc chords of the arcs is positioned, two freely ending additional ribs branch off from each rib portion.

The hatching ribs and the additional ribs may have a cross-sectional shape that differs from the cross-sectional shape described. The hatching ribs and the additional ribs preferably have a cross-sectional shape which is symmetrical with respect to a perpendicular to the hatching base. The rib flanks may extend in a convexly or concavely curved manner overall or at least over the majority of their extent, wherein the transition to the hatching base is realized via a bend or a rounded portion, and wherein the mentioned angle β is between a straight line connecting the end points of the curved rib flanks. Furthermore, the rib flanks may be of stepped form, wherein the angle β between a straight line connecting both ends of the rib flanks is ascertained. Furthermore, the rib flanks may be structured, that is to say provided with a surface structure, for example with a roughness, so that these are provided with extremely small structures.

The hatching ribs may—in relation to their longitudinal-extent directions—extend substantially parallel to one another in plan view, wherein “hatching ribs extending substantially parallel to one another” are to be understood as meaning those for which the extent directions differ from one another by up to 5°.

Furthermore, the hatching ribs—in relation to their longitudinal-extent directions—may extend in an arcuate manner in plan view. In the case of hatching ribs extending substantially parallel to one another and in each case in an arcuate manner, the angle by which the extent directions of the hatching ribs may differ from one another is based on tangents to the respective hatching-rib base lines b_{SR} that extend parallel to one another.

List of reference signs

| | |
|---|---|
| 1 | Vehicle tire |
| 2 | Sidewall |
| 3 | Tread |
| 4, 4′ | Hatching area |
| 5 | Hatching rib |
| 5a | Rib portion |
| 5a₁ | Rib-portion part |
| 5a₂ | Rib-portion part |
| 5b | Inner corner region |
| 5c | Outer corner region |
| 6 | Additional rib |
| 6a | Additional-rib portion |
| 6b | Additional-rib portion |
| 7 | Hatching base |
| 8a | Tip region |
| 8b | Rib flank |
| 9a | Tip region |
| 9b | Rib flank |
| 9c | End flank |
| 10 | Elevation |
| a | Maximum deflection |
| a_{SR}, a_{Z} | Spacing |
| b_{SR} | Hatching-rib base line |
| eₐ, eₐ₁, eₐ₂, e_{Z} | Extent length |
| E_{R} | Longitudinal-extent direction |
| h_{E}, h_{SR}, h_{Z} | Maximum height |
| h₁, h₂, h₄, h₅ | Maximum height |
| h₂*, h₃*, h₅* | Maximum height |
| M_{i, i=1 to 5} | Measurement point |
| m_{SR} | Hatching-rib midline |
| m_{Z} | Rib midline |
| α | Inner angle |
| β, γ | Angle |

1. A vehicle tire having sidewalls and a tread and having at least one hatching area on at least one of the sidewalls and/or on the tread, wherein the hatching area has elongate hatching ribs which extend alongside one another and which have longitudinal-extent directions which extend parallel to one another or largely parallel to one another,
wherein the hatching ribs, when seen in plan view, each extend with a regular waveform and are each made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, wherein, on that side of the hatching ribs on which a hatching-rib base line extending along the long trapezoid bases or along the arc chords of the arcs is positioned, two freely ending additional ribs branch off from each rib portion.

2. The vehicle tire as claimed in claim 1, wherein the additional ribs branching off from the same rib portion, when seen in plan view, extend in a V-shaped manner with respect to one another and in a manner inclined oppositely with respect to one another in relation to the longitudinal-extent direction of the hatching rib and approach one another in the direction of the hatching rib.

3. The vehicle tire as claimed in claim 2, wherein the additional ribs-branching off from the same rib portion, when seen in plan view, are inclined correspondingly relative to the longitudinal-extent direction of the hatching rib.

4. The vehicle tire as claimed in claim 2, wherein the additional ribs extending in a V-shaped manner with respect to one another include an angle of 15° to 25°, in particular of 18° to 22°.

5. The vehicle tire as claimed in claim 1, wherein the additional ribs branching off from the same rib portion adjoin the respective hatching rib with a mutual spacing.

6. The vehicle tire as claimed in claim 1, wherein the additional ribs, when seen in plan view, pass through the hatching-rib base line, wherein the additional ribs, when seen in plan view, preferably each have a first additional-rib portion, which extends from the hatching-rib base line to the hatching rib, and a second additional-rib portion, which adjoins, and is configured to be longer than, the first additional-rib portion.

7. The vehicle tire as claimed in claim 1, wherein the additional ribs have a width which decreases continuously to the hatching rib.

8. The vehicle tire as claimed in claim 1, wherein the rib portions extend in the manner of isosceles trapezoids without a long base, so that each rib portion is made up of a rib-portion part (Sail which forms the short base of the trapezoid and of two rib-portion parts which form a trapezoid leg in each case, wherein the one additional rib proceeds from the mutual connection region of the rib-portion part forming the short base of the trapezoid at the rib-portion part forming the one trapezoid leg, and the other additional rib proceeds from the mutual connection region of the rib-portion part forming the short base of the trapezoid at the rib-portion part forming the other trapezoid leg.

9. The pneumatic vehicle tire as claimed in claim 1, wherein the additional ribs each have an extent length of 0.30 mm to 0.50 mm, in particular of 0.35 mm to 0.45 mm.

10. The vehicle tire as claimed in claim 1, wherein the rib portions of all the hatching ribs point in a manner oriented correspondingly in relation to the longitudinal-extent direction and thus point in a corresponding direction in relation to the longitudinal-extent direction.

11. The vehicle tire as claimed in claim 1, wherein hatching ribs extending adjacently to one another have to one another a mutual spacing, based on the hatching-rib base lines and ascertained perpendicularly thereto, of at least 0.50 mm, and in particular of up to 0.80 mm.

12. The vehicle tire as claimed in claim 1, wherein hatching ribs extending directly alongside one another are offset from one another in their longitudinal-extent direction.

13. The vehicle tire as claimed in claim 2, wherein the hatching ribs extending directly alongside one another are offset from one another in their longitudinal-extent direction in such a way that, in each case when seen in plan view,
for each middle hatching rib, which has two adjacently extending hatching ribs, the additional ribs, extending parallel to one another, that form the one V leg extend in a manner aligned with the corresponding additional ribs from the one adjacent hatching rib and the additional ribs, extending parallel to one another, that form the other V leg extend in a manner aligned with the corresponding additional ribs from the other adjacent hatching rib, and
for each edge-side hatching rib, which has one adjacently extending hatching rib, only the additional ribs, extending parallel to one another, that form the one V leg extend in a manner aligned with the corresponding additional ribs from the adjacent hatching rib.

14. The vehicle tire as claimed in claim 1, wherein, between the additional ribs branching off from the same rib portion, there is formed in each case one free-standing, peg-shaped elevation which has a maximum height of 0.05 mm to 0.80 mm, in particular of 0.10 mm to 0.50 mm, wherein the maximum height of the peg-shaped elevation is preferably less than the maximum height of the additional ribs, and/or wherein the maximum height of the peg-shaped elevation is preferably less than the maximum height of the hatching ribs.

15. A vulcanization mold for shape-imparting vulcanization of the vehicle tire as claimed in claim 1, wherein the vulcanization mold has at least one mold surface having a negative contour of a hatching area with elongate hatching ribs which extend alongside one another and which have longitudinal-extent directions which extend parallel to one another or largely parallel to one another, wherein
the negative contour has the following:
first depressions for forming hatching ribs, said hatching ribs, when seen in plan view, each extending with a regular waveform and each being made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, and
second depressions for forming on that side of the hatching ribs on which a hatching-rib base line extending along the long trapezoid bases or along the arc chords of the arcs is positioned two freely ending additional ribs which branch off from each rib portion.

16. A method for producing the vehicle tire as claimed in claim 1, wherein the method comprises the following steps:
a) engraving a negative contour for forming a hatching area into a mold surface of a vulcanization mold for shape-imparting vulcanization of a vehicle tire by means of laser engraving, wherein the negative contour has the following:
first depressions for forming hatching ribs, said hatching ribs, when seen in plan view, each extending with a regular waveform and each being made up of rib portions which adjoin one another and which extend in the manner of isosceles trapezoids without a long base that are oriented correspondingly in relation to the longitudinal-extent direction or which extend in the manner of arcs that are oriented correspondingly in relation to the longitudinal-extent direction, and
second depressions for forming on that side of the hatching ribs on which a hatching-rib base line extending along the long trapezoid bases or along the arc chords of the arcs is positioned two freely ending additional ribs which branch off from each rib portion,
b) performing shape-imparting vulcanization of a tire blank by means of the vulcanization mold, whereby a hatching area with hatching ribs and additional ribs is stamped into an outer surface of the vehicle tire, in particular a sidewall and/or the tread of the vehicle tire.
